(19) United States
(12) Patent Application Publication
(10) Pub. No.: US 2026/0178073 A1
(43) Pub. Date: Jun. 25, 2026

(54) GLITCHFREE CLOCK SWITCHING CIRCUIT

(71) Applicant: RENESAS ELECTRONICS CORPORATION, Tokyo (JP)

(72) Inventor: Frank Guenter HANSEN, Dusseldorf (DE)

(21) Appl. No.: 19/398,191

(22) Filed: Nov. 24, 2025

(30) Foreign Application Priority Data
Dec. 20, 2024 (DE) 10 2024 139 146.4

(51) Int. Cl. G06F 1/06

(52) U.S. Cl. CPC G06F 1/06

(57) ABSTRACT

To provide a semiconductor device circuit configured to switch glitchfree between a plurality of independent Ethernet clock sources for operating a network interface. The semiconductor device comprises a clock provision unit comprising at least a first circuit branch configured to receive a first clock signal from a first clock source associated with a first network interface, and a second circuit branch configured to receive a second clock signal from a second clock source associated with a second network interface, the second clock source having a different clock rate than the first clock source.

### CROSS-REFERENCE TO RELATED APPLICATIONS

The disclosure of German Patent Application No. 10 2024 139 146.4 filed on December. 20, 2024, including the specification, drawings and abstract is incorporated herein by reference in its entirety.

### BACKGROUND

The present document relates to data communications in an Ethernet network. In particular, the present document relates to a device, system and method for smooth clock switching in a multi-rate Ethernet network.

Modern Ethernet networks allows for scalable data rates for various communication technologies. As specified by IEEE 802.3, 1 Gbps Ethernet (GE) provides data rates of 10 Mb/s, 100 Mb/s, and 1000 Mb/s (i.e., 1 Gb/s). Due to its simplicity and technical feasibility, these data rates of 1GE are able to utilize the existing equipment, component, and wiring infrastructure as the data rates progress, without significant additional cost.

On the other hand, clock synchronization needs to be realized in Ethernet networks. In order to support Ethernet networks with the above variable 1GE data rates, an Ethernet system may employ a multi-rate interface between a media access controller (MAC) layer and a physical (PHY) layer, which shall allow for proper determination/selection of an Ethernet clock source for realizing adaptive speed control of a MAC and a PHY chip within the Ethernet system. For example, a clock supply for a triple PHY layer (i.e., Ethernet physical layer) supporting Ethernet with data rates of 10 Mb/s, 100 Mb/s, and 1 Gb/s may need to change/switch between 2.5MHz, 25MHz and 125MHz for realization of these speeds/data rates.

However, switching between these different clock speeds of an Ethernet clock source operating at frequencies of 2.5MHz, 25MHz and 125MHz and with different clock cycles may cause a “glitch” to occur. In general, a clock source operating at 125MHz may be provided by a MAC chip (i.e., an SoC (System-on-chip) device with the MAC layer), while a clock source operating at 2.5MHz or 25MHz may be provided by a PHY chip, of an Ethernet system. The PHY chip may determine a clock speed by auto-negotiation, and then the SoC with the MAC may have to react to the outcome of this negotiation. However, with different vendors for the PHY chip, the behavior of the PHY chip may differ during a clock switching process (e.g., an original clock signal may stop at 1 or at 0 level). As a result, the Ethernet system may get stuck during the changes of clock speeds (e.g., between 2.5MHz, 25MHz and 125MHz), especially if the original clock stops while remaining at 1 level.

Thus, there is a need for an improved clock-switching mechanism that switches glitchfree from one clock to another to change the frequency of a clock signal in operation of a multi-rate network interface for an Ethernet system. In particular, it is desirable for realizing glitch-free switchover between Ethernet clock sources for supplying a clock signal within an Ethernet system.

### SUMMARY

The present document is therefore directed at dynamic source clock switching, especially at glitch-free dynamic switching of clock supply, for Ethernet systems (e.g., triple PHY with SoC supporting various network interfaces such as a gigabit media-independent interface (GMII) and a media-independent interface (MII)).

According to an aspect, there is provided a semiconductor device which is configured to switch glitchfree between a plurality of independent Ethernet clock sources for operating a network interface. The semiconductor device comprises a clock provision unit comprising at least a first circuit branch configured to receive a first clock signal from a first clock source associated with a first network interface, and a second circuit branch configured to receive a second clock signal from a second clock source associated with a second network interface. According to the disclosure of the present document, the second clock source may have a different clock rate than the first clock source.

The semiconductor device further comprises a clock selecting unit coupled to the first circuit branch and the second circuit branch and configured to select either one of the first clock source and the second clock source as a selected clock source in response to a clock switching signal. Herein, the clock provision unit is configured to provide an output clock signal from the selected clock source.

In particular, the clock selecting unit comprises state machine circuitry configured to receive the clock switching signal and to provide, based on the clock switching signal, at least a first control signal for controlling the first circuit branch and a second control signal for controlling the second circuit branch. In this way, in response to the clock switching signal indicating that the second clock source is to be selected as the selected clock source, the state machine circuitry is configured to deactivate the first circuit branch by the first control signal prior to activating the second circuit branch by the second control signal for providing the second clock signal as the output clock signal.

Configured as above, the proposed device according to the disclosure of the present document provides an improved clock-switching mechanism that allows for glitch-free switchover between Ethernet clock sources. In particular, by appropriately controlling (via the state machine circuitry) the first and second circuit branch of the clock provision unit, it is allowed to prevent an output clock signal from being stuck when each clock source is dynamically activated/deactivated.

In some embodiments, the first circuit branch may comprise a first synchronous stage and a first asynchronous stage. In particular, the first control signal may comprise a first synchronous control signal for activating or deactivating the first synchronous stage, and a first asynchronous control signal for activating or deactivating the first asynchronous stage. Moreover, the first synchronous stage may be configured to receive the first clock signal and the first synchronous control signal, and the first asynchronous stage may be coupled to the first synchronous stage and configured to receive the first asynchronous control signal.

In some embodiments, for deactivating the first circuit branch, the state machine circuitry may be configured to deactivate the first synchronous stage using the first synchronous control signal. Subsequently, the state machine circuitry may be configured to deactivate the first asynchronous stage using the first asynchronous control signal.

In some embodiments, the second circuit branch may comprise a second synchronous stage and a second asynchronous stage. In particular, the second control signal may comprise a second synchronous control signal for activating or deactivating the second synchronous stage, and a second asynchronous control signal for activating or deactivating the second asynchronous stage. More specifically, the second synchronous stage may be configured to receive the second clock signal and the second synchronous control signal, and the second asynchronous stage may be coupled to the second synchronous stage and configured to receive the second asynchronous control signal.

In some embodiments, for activating the second circuit branch, the state machine circuitry may be configured to activate the second asynchronous stage using the second asynchronous control signal. Subsequently, the state machine circuitry may be configured to activate the second synchronous stage using the second synchronous control signal.

In some embodiments, the second clock source may be operatable at two or more distinct clock rates. Besides, the second circuit branch may be configured to provide to the state machine circuitry a clock indication signal indicative of an actual operating clock rate of the second clock source among the two or more distinct clock rates based on the second control signal. In response to the clock switching signal indicating that the first clock source is to be selected as the selected clock source, the state machine circuitry may be configured to deactivate the second circuit branch in response to the clock indication signal.

In some embodiments, the clock indication signal may be provided by the second synchronous stage based on the second synchronous control signal. In response to the clock switching signal indicating that the first clock source is to be selected as the selected clock source, the state machine circuitry may be configured to deactivate the second synchronous stage using the second synchronous control signal. In particular, the deactivation of the second synchronous stage may cause a change of a logic level in the clock indication signal after a predefined number of cycles of the second clock signal. Also, the state machine circuitry may be configured to further deactivate the second asynchronous stage in response to the change of a logic level in the clock indication signal.

In some embodiments, the predefined number of cycles of the second clock signal may be related to different time durations with respect to the distinct clock rates. Furthermore, the actual operating clock rate of the second clock source may be indicated by a time duration after which the change of a logic level in the clock indication signal is caused.

In some embodiments, the second circuit branch may comprise one or more second synchronization flip flops configured to receive the second clock signal, a second gating latch coupled to the one or more second synchronization flip flops at an input end and configured to gate the second clock signal synchronously, and a second asynchronous AND gate coupled to the second gating latch. In particular, the one or more second synchronization flip flops and the second asynchronous AND gate may be configured to receive the second control signal from the state machine circuitry.

In some embodiments, the second synchronous stage may comprise the one or more second synchronization flip flops configured to receive the second synchronous control signal, and the second gating latch. In particular, the second asynchronous stage may comprise the second asynchronous AND gate configured to receive the second asynchronous control signal and an output of the second synchronous stage. Besides, the second synchronous stage may further comprise a detection flip flop configured to provide the clock indication signal to the state machine circuitry based on the second synchronous control signal.

In some embodiments, the second synchronous stage may be deactivated by setting the second synchronous control signal to 0, and the detection flip flop may be configured to change a logic level in the clock indication signal to 0 after the predefined number of cycles of the second clock signal in response to the deactivation of the second synchronous stage. Also, the state machine circuitry may be configured to further deactivate the second asynchronous stage in response to detecting a 0-level in the clock indication signal. More specifically, the predefined number of cycles of the second clock signal may be dependent on the number of the one or more second synchronization flip flops.

In some embodiments, the first circuit branch may comprise one or more first synchronization flip flops configured to receive the first clock signal, a first gating latch coupled to the one or more first synchronization flip flops, and a first asynchronous AND gate coupled to the first gating latch. In particular, the one or more first synchronization flip flops and the first asynchronous AND gate may be configured to receive the first control signal from the state machine circuitry.

In some embodiments, the first synchronous stage may comprise the one or more first synchronization flip flops configured to receive the first synchronous control signal, and the first gating latch. In particular, the first asynchronous stage may comprise the first asynchronous AND gate configured to receive the first asynchronous control signal and an output of the first synchronous stage.

In some embodiments, the first synchronous stage may be deactivated by setting the first synchronous control signal to 0. Also, the one or more first synchronization flip flops and the first gating latch may be reset to cause a 0-level in the output of the first synchronous stage after a predefined number of cycles of the first clock signal in response to the deactivation of the first synchronous stage. In addition, the state machine circuitry may be configured to further deactivate the first asynchronous stage based on the clock switching signal. More specifically, the predefined number of cycles of the first clock signal may be dependent on the number of the one or more first synchronization flip flops.

In some embodiments, the clock provision unit may further comprise an OR gate coupled to the output of the first asynchronous AND gate and the output of the second asynchronous AND gate and configured to provide the output clock signal based on the output of the first asynchronous AND gate and the output of the second asynchronous AND gate.

In some embodiments, the state machine circuitry may be configured to receive a third clock signal from a third clock source for timing of the state machine circuitry for gating the first clock signal and the second clock signal.

In some embodiments, the first clock source may have an operating clock rate at a frequency of 125MHz, and the second clock source may have an operating clock rate at a frequency of 2.5MHz or 25MHz. In some embodiments, the first network interface may comprise a gigabit media-independent interface (GMII) between a medium access control (MAC) module and a physical (PHY) layer module. Furthermore, the second network interface may comprise a media-independent interface (MII) between the MAC module and the PHY layer module.

In some embodiments, the clock switching signal may be provided by the MAC layer module and may be indicative of a subsequent operating rate of the MAC module. Besides, the first clock source may be provided by the MAC module inside an application-specific integrated circuit (ASIC), and the second clock source may be provided by the PHY layer module external to the ASIC.

Configured as above, the additional utilization of the (first and second) asynchronous stages in the clock provision circuit allows for gating the independent (Ethernet) clocks appropriately to effectively avoid hanging of the system. Furthermore, by informing the state machine (via the clock indication signal) of an actual operating clock rate of the second clock source in good time, unnecessary waiting time can be avoided prior to switching to another clock source (e.g., the first clock source), thereby further enhancing the efficiency in the clock switching process.

According to a further aspect, there is provided a system for implementing a multi-rate Ethernet network. The system comprises a physical layer (PHY) module and a media access control (MAC) module configured to communicate data with an Ethernet network at multiple data rates via the PHY layer module.

In particular, the PHY layer module is configured to receive a first clock signal from the MAC module for transferring data at a first data rate, and to provide a second clock signal to the MAC module for transferring data at a second data rate. The system further comprises a multi-rate interface module configured to connect the MAC module to the PHY layer module. Specifically, the multi-rate interface module is operatable in a first interface mode as a first network interface between the MAC module and the PHY layer module for transferring data at the first data rate using the first clock signal, and in a second interface mode as a second network interface between the MAC module and the PHY layer module for transferring data at the second data rate using the second clock signal.

The system also comprises a clock switching module comprising a semiconductor device according to any one of the above-described aspect and its related embodiments. In particular, the clock switching module is configured to switch glitchfree between the first clock signal and the second clock signal, and to provide an output clock signal to the PHY layer module and the MAC module based on the clock switching signal provided by the MAC layer module for properly operating the multi-rate interface module, either in the first interface mode, or in the second interface mode.

In some embodiments, the first interface mode may comprise a gigabit media-independent interface (GMII) mode, and the second interface mode may comprise a media-independent interface (MII) mode.

In some embodiments, the first clock signal may have an operating frequency greater than the second clock signal. More specifically, the first clock signal may have an operating frequency of 125MHz. Alternatively or in addition, the second clock signal may have an operating frequency of 2.5MHz or 25MHz.

In some embodiments, the MAC module and the clock switching module may be integrated inside an application-specific integrated circuit (ASIC). Alternatively or in addition, the PHY layer module and the multi-rate interface module may be integrated inside a PHY chip external to the ASIC.

In some embodiments, the clock switching signal may be provided based on determining, for a subsequent operation of the MAC module, an operating frequency of the output clock signal by auto-negotiation of the PHY layer module. Accordingly, the PHY layer module may be configured to stop the second clock signal based on the determination of the auto-negotiation.

Configured as above, an improved Ethernet system with increased reliability can be provided where efficient glitch-free switching between Ethernet clocks is ensured, especially when the system switches from e.g., the 25MHz clock in the MII mode to the 125MHz clock in the GMII mode.

According to a further aspect, there is provided a method for glitchfree switching between a plurality of independent Ethernet clock sources for operating a network interface. The method comprises receiving, at a first circuit branch, a first clock signal from a first clock source associated with a first network interface. The method also comprises receiving, at a second circuit branch, a second clock signal from a second clock source associated with a second network interface. According to the disclosure of the present document, the second clock source may have a different clock rate than the first clock source. The method further comprises selecting either one of the first clock source and the second clock source as a selected clock source in response to a clock switching signal, and providing an output clock signal from the selected clock source.

Specifically, the selection of either one of the first clock source and the second clock source comprises providing, based on the clock switching signal, at least a first control signal for controlling the first circuit branch and a second control signal for controlling the second circuit branch. In addition, the selection of either one of the first clock source and the second clock source also comprises, in response to the clock switching signal indicating that the second clock source is to be selected as the selected clock source, deactivating the first circuit branch by the first control signal prior to activating the second circuit branch by the second control signal for providing the second clock signal as the output clock signal.

In some embodiments, the first control signal may comprise a first synchronous control signal for activating or deactivating a first synchronous stage of the first circuit branch, and a first asynchronous control signal for activating or deactivating a first asynchronous stage of the first circuit branch coupled to the first synchronous stage. In particular, the method may further comprise receiving the first synchronous control signal at the first synchronous stage and receiving the first asynchronous control signal at the first asynchronous stage.

In some embodiments, deactivating the first circuit branch may further comprise deactivating the first synchronous stage using the first synchronous control signal, and subsequently, deactivating the first asynchronous stage using the first asynchronous control signal.

In some embodiments, the second control signal may comprise a second synchronous control signal for activating or deactivating a second synchronous stage of the second circuit branch, and a second asynchronous control signal for activating or deactivating a second asynchronous stage of the second circuit branch coupled to the second synchronous stage. In particular, the method may further comprise receiving the second synchronous control signal at the second synchronous stage and receiving the second asynchronous control signal at the second asynchronous stage.

In some embodiments, activating the second circuit branch may further comprise activating the second asynchronous stage using the second asynchronous control signal, and subsequently, activating the second synchronous stage using the second synchronous control signal.

In some embodiments, the second clock source may be operatable at two or more distinct clock rates. The method may further comprise providing a clock indication signal indicative of an actual operating clock rate of the second clock source among the two or more distinct clock rates based on the second control signal. Optionally, the method may also comprise, in response to the clock switching signal indicating that the first clock source is to be selected as the selected clock source, deactivating the second circuit branch in response to the clock indication signal.

In some embodiments, the clock indication signal may be provided by the second synchronous stage based on the second synchronous control signal. The method may further comprise, in response to the clock switching signal indicating that the first clock source is to be selected as the selected clock source, deactivating the second synchronous stage using the second synchronous control signal. Notably, the deactivation of the second synchronous stage may cause a change of a logic level in the clock indication signal after a predefined number of cycles of the second clock signal. In addition, the method may comprise deactivating the second asynchronous stage in response to the change of a logic level in the clock indication signal.

In some embodiments, the predefined number of cycles of the second clock signal may be related to different time durations with respect to the distinct clock rates. In particular, the actual operating clock rate of the second clock source may be indicated by a time duration after which the change of a logic level in the clock indication signal is caused.

In some embodiments, the first circuit branch and the second circuit branch may be formed by a plurality of logical elements including one or more of a flip flop, a gating latch, an AND gate, and an OR gate.

In some embodiments, deactivating the second synchronous stage may comprise setting the second synchronous control signal to 0. The method may further comprise changing a logic level in the clock indication signal to 0 after the predefined number of cycles of the second clock signal in response to the deactivation of the second synchronous stage, and deactivating the second asynchronous stage in response to detecting a 0-level in the clock indication signal.

In some embodiments, the first clock source may have an operating clock rate at a frequency of 125MHz for operating a gigabit media-independent interface (GMII) between a medium access control (MAC) module and a physical (PHY) layer module. Alternatively or in addition, the second clock source may have an operating clock rate at a frequency of 2.5MHz or 25MHz for operating a media-independent interface (MII) between the MAC module and the PHY layer module.

Configured as above, the proposed method according to the disclosure of the present document realizes an improved clock multiplexing that switches glitchfree from one clock to another to change the frequency of a clock signal in operation of a multi-rate network interface for an Ethernet system. In particular, the proposed method can reliably deactivate one circuit branch while activating another branch to ensure reliable function to be performed in the Ethernet system. Moreover, by indicating the status regarding the current clock/interface mode in the clock selection process, the proposed method enables faster turnover to the subsequently-selected clock (e.g., the GMII clock), thereby enhancing the efficiency of the clock switching process.

It should be noted that the methods and systems including its preferred embodiments as outlined in the present document may be used stand-alone or in combination with the other methods and systems disclosed in this document. In addition, the features outlined in the context of a system are also applicable to a corresponding method. Furthermore, all aspects of the methods and systems outlined in the present document may be arbitrarily combined. In particular, the features of the claims may be combined with one another in an arbitrary manner.

In the present document, the term “couple” or “coupled” refers to elements being in electrical communication with each other, whether directly connected e.g., via wires, or in some other manner.

### BRIEF DESCRIPTION OF THE DRAWINGS

FIG. 1 is a schematic illustration of an example clock switching device 100 according to present embodiments.

FIG. 2 is a schematic illustration of an example clock switching device 200 according to the present embodiments.

FIG. 3 is an illustration of an exemplary diagram of a state machine 300 for providing the control signals 102a, 102b to the clock provision unit 101 according to the present embodiments.

FIG. 4 is a schematic illustration an example architecture of a system 400 employing the proposed clock switching device 100, 200 according to the present embodiments.

FIG. 5 is a flow chart of an example method 500 for glitchfree switching between a plurality of independent Ethernet clock sources for operating a network interface according to the present embodiments.

### DETAILED DESCRIPTION

As indicated above, the present document is directed at providing an improved clock-switching mechanism that allows for switching glitchfree from one clock to another to change the frequency of a clock signal in operation of a multi-rate network interface for an Ethernet system. Specifically, the present document proposes a semiconductor device (as a clock switching device) and a method for realizing glitch-free switchover between Ethernet clock sources for supplying a clock signal within an Ethernet system, as described below. Besides, the present document also proposes an Ethernet system that includes the described glitch-free clock switching device. In particular, the present document proposes a multiplexing technique to prevent an output clock signal from being stuck when each clock source is dynamically activated/deactivated.

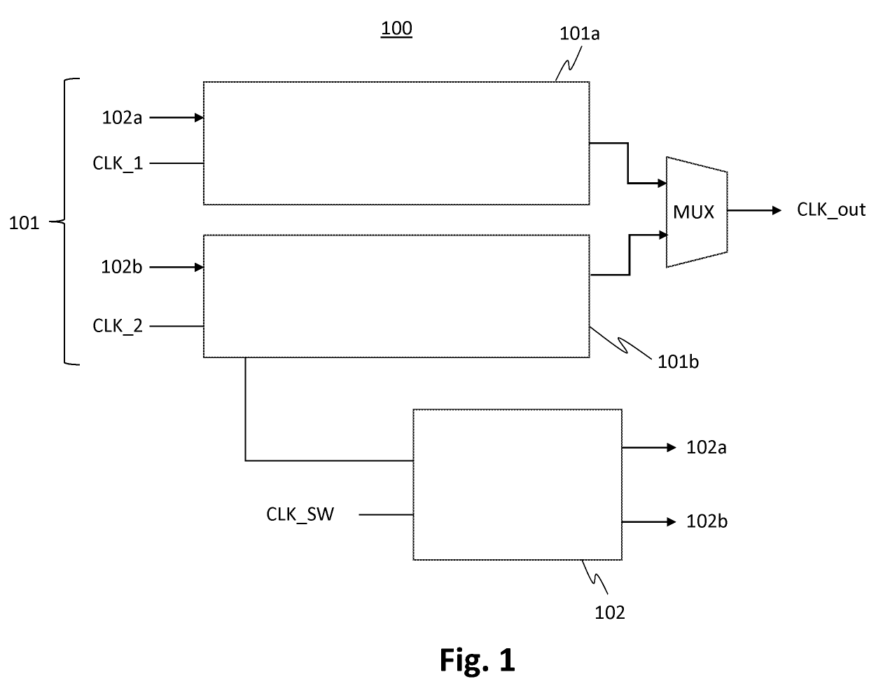

FIG. 1 schematically illustrates an example clock switching device 100 according to embodiments of the present document. In particular, the clock switching device 100 may be a semiconductor device or circuit (e.g., SoC devices such as Application-Specific Integrated Circuits (ASICs)) configured to switch glitchfree between independent Ethernet clock sources (e.g., CLK_1, CLK_2, etc.) for operating a network interface (e.g., between the MAC and the PHY) in an Ethernet system. As shown in FIG. 1, the semiconductor device/circuit 100 may include a clock provision unit 101 coupled to the Ethernet clock sources for providing an output clock signal CLK_out, and a clock selecting unit 102 coupled to the clock provision unit 101 for selecting an Ethernet clock source (e.g., CLK_1 or CLK_2) for provision of the output clock signal CLK_out. For example, the clock provision unit 101 may have two or more circuit branches each coupled to a respective clock source for receiving a clock signal from that respective clock source. These two or more circuit branches may be combined using a multiplexer MUX which may output a resulting clock signal (either CLK_1 or CLK_2, as the output clock signal CLK_out) based on the selection of the clock selecting unit 102.

In detail, as shown in the example of FIG. 1, the clock provision unit 101 may include a first circuit branch 101a configured to receive a first clock signal CLK_1, and a second circuit branch 101b configured to receive a second clock signal CLK_2. The first clock signal CLK_1 may come from or may be provided by a first clock source associated with a first network interface (not shown in FIG. 1), and the second clock signal CLK_2 may come from or may be provided by a second clock source associated with a second network interface (not shown in FIG. 1). It should be noted that the first network interface and the second network interface may relate to different data rates, and thus the second clock source may have a different clock rate than the first clock source.

For example, the first network interface may include a gigabit media-independent interface (GMII) between a medium access control (MAC) module and a physical (PHY) layer module, and the second network interface comprises a media-independent interface (MII) between the MAC module and the PHY layer module, of the Ethernet system. Accordingly, the first clock source may have an operating clock rate at a frequency of 125MHz (i.e., the frequency of the first clock signal CLK_1), and the second clock source may have an operating clock rate at a frequency of 2.5MHz or 25MHz (i.e., the frequency of the second clock signal CLK_2).

As further shown in the example of FIG. 1, the clock selecting unit 102 may be coupled to the first circuit branch 101a and the second circuit branch 101b and may be configured to receive a clock switching signal CLK_SW to select either one of the first clock source (CLK_1) and the second clock source (CLK_2) as a selected clock source. Based on the selection, the clock provision unit 101 may provide the output clock signal CLK_out from the selected clock source (i.e., either CLK_1 or CLK_2).

More specifically, the clock selecting unit 102 may include state machine circuitry (e.g., a finite-state machine, FSM) configured to receive the clock switching signal CLK_SW and to control the provision of the output clock signal CLK_out by the clock provision unit 101. As shown in FIG. 1, the state machine circuitry may provide a first control signal 102a for controlling the first circuit branch 101a and a second control signal 102b for controlling the second circuit branch 101b, based on the clock switching signal CLK_SW. In response to the clock switching signal CLK_SW indicating that the second clock source (CLK_2) is to be selected as the selected clock source, the state machine circuitry may be configured to deactivate the first circuit branch 101a by the first control signal 102a prior to activating the second circuit branch 101b by the second control signal 102b, so that the second clock signal CLK_2 may be provided as the output clock signal CLK_out.

In some exemplary implementations, the change of the clock switching signal CLK_SW may be initiated by the PHY layer module and may indicate a subsequent operating rate of the MAC module. In some exemplary implementations, the MAC module may reside in an ASIC (which may not necessarily include the PHY module). In these examples, the first clock source (CLK_1) may be provided by the MAC module inside the ASIC, and the second clock source (CLK_2) may be provided by the PHY layer module external to the ASIC.

It is noted that the aforementioned exemplary implementations of the clock switching device 100 having two circuit branches 101a, 101b is a non-limiting example for switching glitchfree between the Ethernet clock sources. It is appreciated that other numbers of circuit branches and other types of network interfaces (and thus corresponding to other clock rates) are feasible and within the scope of the disclosure in the present document.

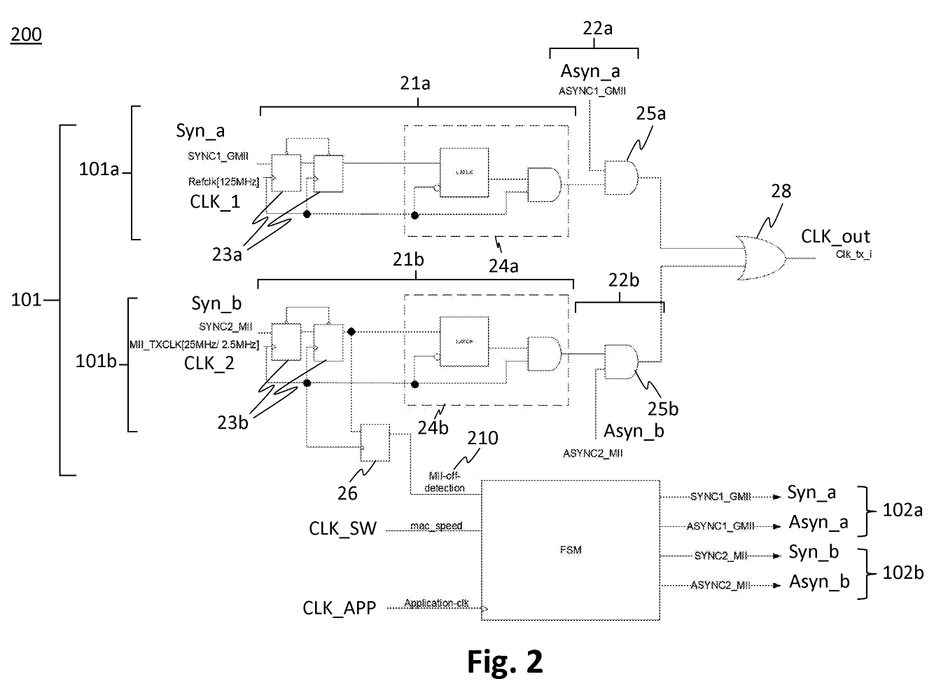

FIG. 2 schematically illustrates an example clock switching device 200 according to embodiments of the present document. It is appreciated that the clock switching device 200 may be a detailed view as one of the examples for implementing the clock switching device 100. That is, the clock switching device 200 may also contain the clock provision unit 101 and the clock selecting unit 102 of the clock switching device 101 as shown in FIG. 1.

As shown in FIG. 2, the first circuit branch 101a may have a first synchronous stage 21a and a first asynchronous stage 22a. Specifically, the first control signal 102a may comprise a first synchronous control signal Syn_a for activating or deactivating the first synchronous stage 21a and a first asynchronous control signal Asyn_a for activating or deactivating the first asynchronous stage 22a. In particular, the first synchronous stage 21a may be configured to receive the first clock signal CLK_1 and the first synchronous control signal Syn_a, and the first asynchronous stage 22a may be coupled to the first synchronous stage 21a and configured to receive the first asynchronous control signal Asyn_a.

Accordingly, for deactivating the first circuit branch 101a, the state machine circuitry 102 may be configured to deactivate the first synchronous stage 21a using the first synchronous control signal Syn_a, and subsequently, to deactivate the first asynchronous stage 22a using the first asynchronous control signal Asyn_a.

As further shown in FIG. 2, the second circuit branch 101b may have a second synchronous stage 21b and a second asynchronous stage 22b. Specifically, the second control signal 102b may comprise a second synchronous control signal Syn_b for activating or deactivating the second synchronous stage 21b and a second asynchronous control signal Asyn_b for activating or deactivating the second asynchronous stage 22b. In particular, the second synchronous stage 21b may be configured to receive the second clock signal CLK_2 and the second synchronous control signal Syn_b, and the second asynchronous stage 22b may be coupled to the second synchronous stage 21b and configured to receive the second asynchronous control signal Asyn_b.

Accordingly, for activating the second circuit branch 101b, the state machine circuitry 102 may be configured to activate the second asynchronous stage 22b using the second asynchronous control signal Asyn_b, and subsequently, to activate the second synchronous stage 21b using the second synchronous control signal Syn_b.

In an example where the second network interface is an MII between the MAC module and the PHY layer module, the second clock source (CLK_2) may be operatable at two or more distinct clock rates (e.g., having an operating clock rate at a frequency of 2.5MHz or 25MHz). In this case, the second circuit branch 101b may be configured to provide to the state machine circuitry 102 a clock indication signal 210 indicative of an actual operating clock rate of the second clock source (CLK_2) among the distinct clock rates based on the second control signal 102b. In particular, in response to the clock switching signal CLK_SW indicating that the first clock source (CLK_1) is to be selected as the selected clock source, the state machine circuitry 102 may be configured to deactivate the second circuit branch 101b in response to the clock indication signal 210.

More specifically, the clock indication signal 210 may be provided by the second synchronous stage 21b based on the second synchronous control signal Syn_b. Accordingly, in response to the clock switching signal CLK_SW indicating that the first clock source (CLK_1) is to be selected as the selected clock source, the state machine circuitry 102 may be configured to deactivate the second synchronous stage 21b using the second synchronous control signal Syn_b. Herein, the deactivation of the second synchronous stage 21b may cause a change of a logic level (e.g., from level 1 to level 0, or vice versa) in the clock indication signal 210 after a predefined number of cycles of the second clock signal CLK_2. Subject to the deactivation of the second synchronous stage 21b, the state machine circuitry 102 may be configured to further deactivate the second asynchronous stage 22b in response to the change of a logic level in the clock indication signal 210.

It is noted that the predefined number of cycles of the second clock signal CLK_2 may be related to different time durations with respect to the distinct clock rates (e.g., 2.5MHz, 25MHz, etc.). Accordingly, the actual operating clock rate of the second clock source (CLK_2) may be indicated by a time duration after which the change of a logic level in the clock indication signal 210 is caused. For example, if a logic level in the clock indication signal 210 changes after 1200ns (which corresponds to three times the duty cycle of the 2.5MHz clock signal), it may indicate that the actual operating clock rate of the second clock source (CLK_2) should be 2.5MHz. On the other hand, if a logic level in the clock indication signal 210 changes after 120ns (which corresponds to three times the duty cycle of the 25MHz clock signal), it may indicate that the actual operating clock rate of the second clock source (CLK_2) should be 25MHz.

In an exemplary implementation, the second circuit branch 101b may include one or more second synchronization flip flops 23b configured to receive the second clock signal CLK_2, a second gating latch 24b (e.g., a Gated Clock Latch or a Clock Gate with Latch) coupled to the one or more second synchronization flip flops 23b at an input end and configured to gate (e.g., to switch off/on) the second clock signal CLK_2 synchronously, and a second asynchronous AND gate 25b coupled to the second gating latch 24b. The one or more second synchronization flip flops 23b and the second asynchronous AND gate 25b may be configured to receive the second control signal 102b from the state machine circuitry 102.

The one or more second synchronization flip flops 23b and the second gating latch 24b may form the second synchronous stage 21b. Thus, the second synchronization flip flop(s) 23b may be configured to receive the second synchronous control signal Syn_b. Besides, the second asynchronous AND gate 25b may form the second asynchronous stage 22b and may be configured to receive the second asynchronous control signal Asyn_b and an output of the second synchronous stage 21b. Notably, the second synchronous stage 21b may further include a detection flip flop 26 configured to provide the clock indication signal 210 to the state machine circuitry 102 based on the second synchronous control signal Syn_b.

In particular, the second synchronous stage 21b may be deactivated by setting the second synchronous control signal Syn_b to 0, and the detection flip flop 26 may be configured to change a logic level in the clock indication signal 210 to 0 after the predefined number of cycles of the second clock signal CLK_2 in response to the deactivation of the second synchronous stage 21b. Besides, the state machine circuitry 102 may be configured to further deactivate the second asynchronous stage 22b in response to detecting a 0-level in the clock indication signal 210. It is noted that the predefined number of cycles of the second clock signal CLK_2 may be dependent on the number of the one or more second synchronization flip flops 23b.

In the example of FIG. 2, two second synchronization flip flops 23b are used together with the detection flip flop 26 in the second synchronous stage 21b of the second circuit branch 101b, which may lead to a waiting time of three cycles of the second clock signal CLK_2 for passing the synchronous stage. Accordingly, a logic level in the clock indication signal 210 may change after three times the duty cycle of the second clock signal CLK_2. For example, a waiting time of 1200ns may be needed for the 2.5MHz clock signal, implying that a logic level in the clock indication signal 210 may change after 1200ns if the second clock source (CLK_2) is operated at 2.5MHz. On the other hand, a waiting time of 120ns may be needed for the 25MHz clock signal, implying that a logic level in the clock indication signal 210 may change after 120ns if the second clock source (CLK_2) is operated at 25MHz.

Similarly, the first circuit branch 101a may include one or more first synchronization flip flops 23a configured to receive the first clock signal CLK_1, a first gating latch 24a coupled to the one or more first synchronization flip flops 23a, and a first asynchronous AND gate 25a coupled to the first gating latch 24a. The one or more first synchronization flip flops 23a and the first asynchronous AND gate 25a may be configured to receive the first control signal 102a from the state machine circuitry 102. In particular, the first synchronous stage 21a may include the first gating latch 24a and the one or more first synchronization flip flops 23a configured to receive the first synchronous control signal Syn_a. Besides, the first asynchronous stage 22a may include the first asynchronous AND gate 25a configured to receive the first asynchronous control signal Asyn_a and an output of the first synchronous stage 21a.

In some exemplary implementations, the first synchronous stage 21a may be deactivated by setting the first synchronous control signal Syn_a to 0, and the one or more first synchronization flip flops 23a and the first gating latch 24a may be reset to cause a 0-level in the output of the first synchronous stage 21a after a predefined number of cycles of the first clock signal CLK_1 in response to the deactivation of the first synchronous stage 21a. In addition, the state machine circuitry 102 may be configured to further deactivate the first asynchronous stage 22a based on the clock switching signal CLK_SW. It is noted that the predefined number of cycles of the first clock signal CLK_1 may be dependent on the number of the one or more first synchronization flip flops 23a.

As shown in FIG. 2, the clock provision unit 101 may further include an OR gate 28 coupled to the output of the first asynchronous AND gate 25a and the output of the second asynchronous AND gate 25b and configured to provide the output clock signal CLK_out based on the output of the first asynchronous AND gate 25a and the output of the second asynchronous AND gate 25b.

Moreover, the state machine circuitry 102 may be configured to receive a third clock signal CLK_APP from a third clock source for timing of the state machine circuitry 102 for gating the first clock signal CLK_1 and the second clock signal CLK_2.

It is noted that the aforementioned exemplary implementations of the clock switching device 200 having the circuit structure as explicitly shown in FIG. 2 is a non-limiting example of a clock switching device for switching glitchfree between the Ethernet clock sources according to the disclosure of the present document. It is appreciated that other numbers of synchronization flip flops (and thus other waiting time for indicating the actual operating clock rate of the second clock source), and other types of network interfaces (and thus corresponding to other clock rates) are feasible and within the scope of the disclosure in the present document. Also, it is further understood that connections between the components of the clock switching device 200 may vary according to practical implementations.

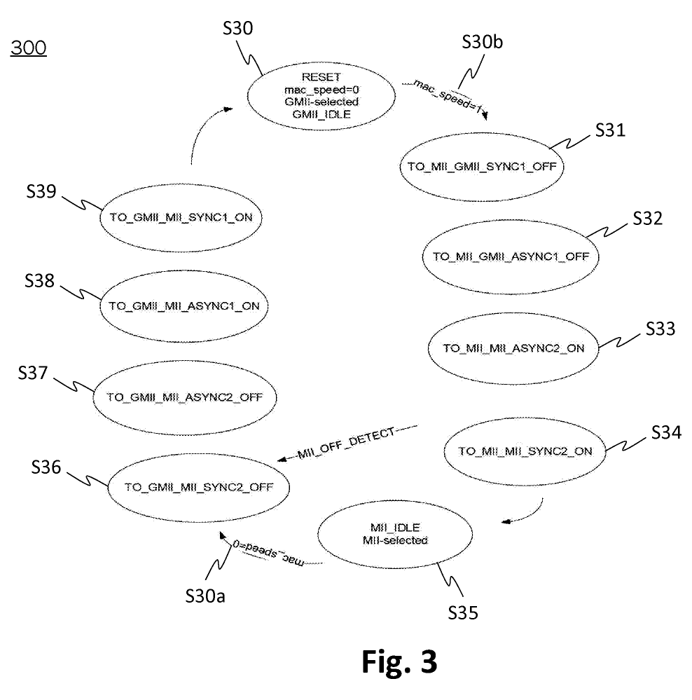

FIG. 3 illustrates an exemplary diagram of a state machine 300 for providing the control signals 102a, 102b to the clock provision unit 101 according to embodiments of the present document. Specifically, the exemplary state machine 300 may be implemented in the above described state machine circuity of the clock selecting unit 102 for determining the first control signal 102a and the second control signal 102b to control the first circuit branch 101a and the second circuit branch 101b, respectively, of the clock provision unit 101.

As shown in FIG. 3, the state machine 300 may be a finite-state machine including ten states S30-S39. Among these states, states S30 and S35 may represent a current interface state indicating a currently-selected network interface (e.g., a GMII or a MII) operated by the Ethernet system (i.e., a current interface mode), while states S31-S34 and S36-S39 may respectively represent an output state (e.g., ON or OFF) of the first and second control signals 102a, 102b for controlling the first and second circuit branches 101a, 101b. For example, state S30 may indicate that the currently-selected network interface is the GMII (e.g., as a “RESET” state where the GMII is selected for the Ethernet system), while state S35 may indicate that the currently-selected network interface is the MII. In addition, states S31 and S39 may represent an output state of the first synchronous control signal Syn_a, states S32 and S38 may represent an output state of the first asynchronous control signal Asyn_a, states S33 and S37 may represent an output state of the second asynchronous control signal Asyn_b, and states S34 and S36 may represent an output state of the second synchronous control signal Syn_b, for example.

In the example of FIG. 3, the state machine 300 may start at S30, where it is indicated that the GMII is the currently-selected network interface, and go through all states S31-S39 in a clock-wise direction. In response to the clock switching signal CLK_SW indicating that the Ethernet system is about to switch to the MII (corresponding to a subsequent operating rate of the MAC module, e.g., mac_speed=1 as indicated by S30b), the state machine 300 may go to state S31 which represents an OFF state of the first synchronous control signal Syn_a to deactivate the first synchronous stage 21a. Subsequently, the state machine 300 may go to state S32 which represents an OFF state of the first asynchronous control signal Asyn_a to deactivate the first asynchronous stage 22a. In this way, the first circuit branch 101a may be deactivated by the state machine circuitry 102.

After deactivation of the first circuit branch 101a, the second circuit branch 101b may be activated by the state machine circuitry 102. To this end, the state machine 300 may continue with state S33 which represents an ON state of the second asynchronous control signal Asyn_b to activate the second asynchronous stage 22b, and with state S34 which represents an ON state of the second synchronous control signal Syn_b to activate the second synchronous stage 21b. When the first circuit branch 101a is deactivated and the second circuit branch 101b is activated, the state machine 300 may reach state S35, where it is indicated that the MII is the currently-selected network interface.

As further shown in FIG. 3, at state S35, the state machine circuitry 102 may receive the clock switching signal CLK_SW indicating that the Ethernet system is about to switch to the GMII (corresponding to a subsequent operating rate of the MAC module, e.g., mac_speed=0 as indicated by S30a). In response, the state machine 300 may then go to state S36 which represents an OFF state of the second synchronous control signal Syn_b to deactivate the second synchronous stage 21b. Subsequently, the state machine 300 may go to state S37 which represents an OFF state of the second asynchronous control signal Asyn_b to deactivate the second asynchronous stage 22b. In this way, the second circuit branch 101b may be deactivated by the state machine circuitry 102.

After deactivation of the second circuit branch 101b, the first circuit branch 101a may be activated by the state machine circuitry 102. To this end, the state machine 300 may continue with state S38 which represents an ON state of the first asynchronous control signal Asyn_a to activate the first asynchronous stage 22a, and with state S39 which represents an ON state of the first synchronous control signal Syn_a to activate the first synchronous stage 21a. When the second circuit branch 101b is deactivated and the first circuit branch 101a is activated, the state machine 300 may return to state S30, where it is indicated that the GMII is again selected as the current network interface operated by the Ethernet system.

It is noted that the aforementioned exemplary state machine 300 as explicitly illustrated in FIG. 3 is a non-limiting example for implementing the state machine circuitry of the clock selecting unit 102. It is appreciated that other numbers of states representing the control signals and other numbers of states representing the currently-selected interface mode are feasible and within the scope of the disclosure in the present document, depending on the circuit structure of the clock switching device 100, 200 and types of network interfaces for the Ethernet system. Also, it is further understood that the state transitioning path of the state machine may vary according to practical implementations, depending on connections between the components (e.g., the clock provision unit 101 and the clock selecting unit 102) of the clock switching device 100, 200.

According to the disclosure of the present document, the proposed clock switching device 100, 200 is configured to perform the clock-switching function as the output of a logical OR (e.g., the OR gate 28 as illustrated in FIG. 2) of multiple clock sources. As indicated above, when each clock source is dynamically activated/deactivated, this output may become stuck, which can be avoided by means of the proposed multiplexing technique. An exemplary implementation of the proposed clock-switching function is described as below according to embodiments of the present document.

For example, when the Ethernet clock is switched from 25MHz (i.e., the MII mode) to 125MHz (i.e., the GMII mode), the 125MHz clock source is activated and the 25MHz clock source is deactivated. The clock switching may be determined by auto-negotiation of the PHY, but the switching process may not be strictly specified and may vary depending on the implementation. Thus, if the 25MHz clock is stopped while remaining at 1 (i.e., at a high level of the clock signal), the output of the logical OR may be fixed at 1 even though the supply of the 125MHz clock starts, which may cause a system hang (i.e., the Ethernet system becomes stuck). This may be avoided by providing an FSM (finite-state machine), e.g., the state machine 300 as illustrated in FIG. 3, to gate both clocks appropriately.

In some implementations, the FSM may use a third clock source (e.g. CLK_APP as illustrated in FIG. 2) with a specific speed. The specific speed may be, but is not particularly limited to, for example, 266MHz which is used by the SoC in some use cases. Besides, the FSM may also receive the clock switching (mac_speed) signal, which indicates the operating speed of the subsequent stage (e.g., at the MAC). The FSM may independently determine which clock (e.g., the clock source associated with the GMII or the clock source associated with the MII) to select based on the mac_speed signal, as described above.

As illustrated in the state transition diagram of FIG. 3, considering the case where the mac_speed signal becomes 1, when the mac_speed signal becomes 1, the system may operate in the MII mode, and thus the output clock should be switched from 125MHz to 25MHz. To unselect the 125MHz (i.e., GMII) clock, the first synchronous control signal Syn_a (SYNC1_GMII) = 0 may be provided to the first synchronous stage 21a, which may be implemented by multiple latches, as illustrated in FIG. 2. After a certain number of clocks, the latches on the 125MHz route (i.e., the first synchronous stage 21 of the first circuit branch 101a) may be reset to 0 (i.e., deactivation of the first synchronous stage). Accordingly, a constant number of clocks may be required for this operation as being managed by the FSM, thereby reducing waiting time during the clock switching process (i.e., no more waiting time than necessary is required).

It is noted that, in addition to the synchronous stages 21a, 21b, the proposed clock switching device 200 includes an asynchronous stage 22a, 22b placed after the respective synchronous stage 21a, 21b. After the deactivation of the first synchronous stage, the first asynchronous control signal Asyn_a (ASYNC1_GMII) = 0 may be provided to the first asynchronous stage 22a. The ASYNC1_GMII may be ANDed (via the AND gate 25a) with the output of the first synchronous stage 21a, which provides the result to the logical OR (i.e., the OR gate 28) of the final stage. In case of switching from the MII mode to the GMII mode, the switching process may be similar as described above, except that the MII route (i.e., the second circuit branch 101b) may be reset to 0 instead of the GMII route.

It is noted that the proposed FSM outputs these control signals Syn_a, Asyn_a, Syn_b, Asyn_b to both the (first/second) synchronous stage (21a/21b) and the (first/second) asynchronous stage (22a/22b), since a synchronous stage may not work properly in case the corresponding clock signal (CLK_1/CLK_2) is already turned off. Accordingly, by additionally utilizing an asynchronous stage in the clock provision circuit, the proposed multiplexer based on the clock switching device 200 allows for gating the independent (Ethernet) clocks appropriately, thereby effectively avoiding hanging of the system.

In some implementations, considering switching from the MII mode to the GMII mode, since the clock switching circuit may not be aware which of the MII mode clock (e.g., either the 2.5MHz clock or the 25MHz clock) is the currently-selected clock it is operating at, the FSM may set the wait time for the slower clock (assuming the slower clock (e.g., the 2.5MHz clock) is the current clock). Consequently, the system would wait for e.g., 1200ns (which is three times 2.5MHz with two cycles for synchronization in addition to one cycle for switching), even if a waiting time of 120ns would be enough. To further reduce the waiting time of the switching process, a clock indication signal (MII-off-detection) 210 may be provided to the FSM to indicate the status in such a case (i.e., an actual operating clock rate of the MII source among the distinct clock rates 2.5MHz and 25MHz), which effectively speeds up the switching to the GMII clock.

Since the clocks CLK_1, CLK_2 may be independent and asynchronous to each other, the proposed clock switching device takes into account a waiting time for the passing of the synchronization stage to ensure glitch-free switching between the clocks without prediction of a point in time at a rising edge in the MII clock signal (MII-TXCLK). In case of 25MHz clock, the waiting time may last for 120ns, while in case of 2.5MHz clock, the waiting time may last for 1200ns. By using the clock indication signal (MII-off-detection) 210 which may indicate, in a use case where the 25MHz clock is currently selected, that a synchronous switching has been reached based on an arrival of the 0 level after 120ns, the FSM can move on to a subsequent state of the switching process already earlier, which effectively reduces the required waiting time (i.e., no more waiting time needed) for the glitch-free switching between the clocks.

Accordingly, the efficiency of the proposed clock switching device in performing glitch-free switching between Ethernet clocks may be further enhanced, especially when switching from the 25MHz clock in the MII mode to the 125MHz clock in the GMII mode.

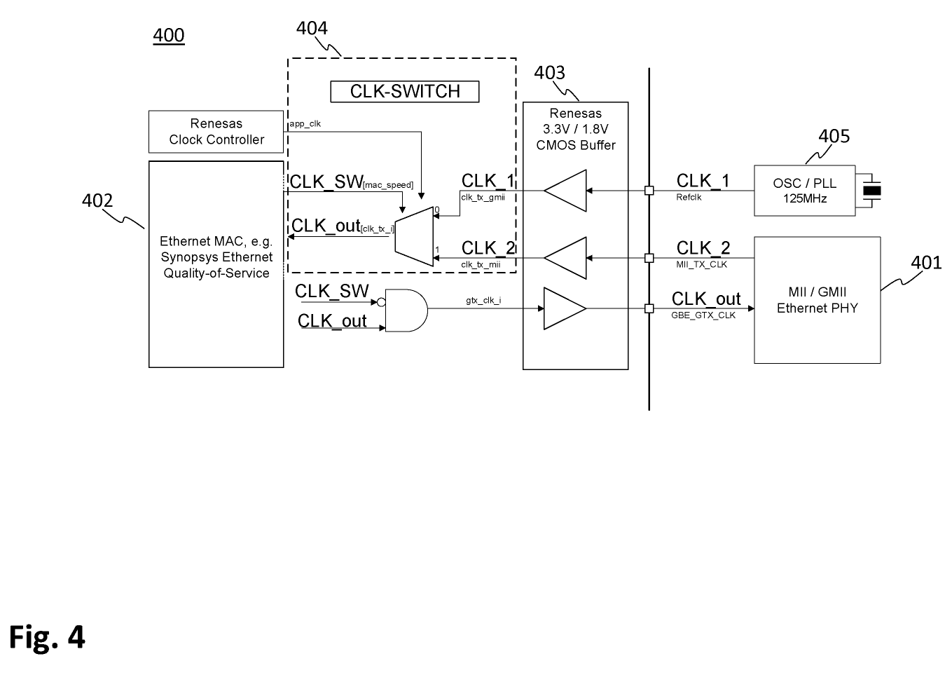

FIG. 4 schematically illustrates an example architecture of a system 400 employing the proposed clock switching device 100, 200 according to embodiments of the present document. In particular, the system 400 may be, for example, an Ethernet system for implementing a multi-rate Ethernet network as described above, and may include a physical layer (PHY) module 401, a media access control (MAC) module 402, and a multi-rate interface module configured to connect the MAC module to the PHY layer module, so that the system 400 may operate at various Ethernet data rates (e.g., 10 Mb/s, 100 Mb/s, and 1 Gb/s, etc.). As shown in the example of FIG. 4, the multi-rate interface module may be integrated within the PHY module 401 (and thus may share the same reference sign 401) to provide a plurality of interface modes (e.g., the MII and GMII modes) associated with the various Ethernet data rates. In an example of an 1GE Ethernet system, the PHY module 401 may be known as a triple Ethernet PHY to allow for data transfer at e.g., 10 Mb/s, 100 Mb/s, and 1 Gb/s.

The MAC module 402 may be configured to communicate data with an Ethernet network at multiple data rates (e.g., 10 Mb/s, 100 Mb/s, and 1 Gb/s, etc.) via the PHY layer module 401. In detail, the PHY layer module 401 may be configured to receive a first clock signal from the MAC module 402 for transferring data at a first data rate (e.g., 1 Gb/s), and to provide a second clock signal to the MAC module 402 for transferring data at a second data rate (e.g., 10 Mb/s, 100 Mb/s, etc.). It is noted that the first clock signal and the second clock signal as illustrated in FIG. 4 may correspond to the first clock signal CLK_1 and the second clock signal CLK_2 as illustrated in FIGS. 1 and 2, respectively, and thus may share the same reference signs for the sake of clarity.

Specifically, the multi-rate interface module 401 may be operatable in a first interface mode (e.g., the GMII mode) as a first network interface between the MAC module 402 and the PHY layer module 401 for transferring data at the first data rate using the first clock signal CLK_1. Besides, the multi-rate interface module 401 may also be operatable in a second interface mode (e.g., the MII mode) as a second network interface between the MAC module 402 and the PHY layer module 401 for transferring data at the second data rate using the second clock signal CLK_2. According to some examples, the first clock signal CLK_1 may have an operating frequency of 125MHz, and the second clock signal CLK_2 may have an operating frequency of 2.5MHz or 25MHz.

In addition, the system 400 may further include a clock switching module 404 configured to switch glitchfree between the first clock signal CLK_1 and the second clock signal CLK_2. In particular, the clock switching module 404 may include the proposed clock switching device 100, 200 as illustrated in FIGS. 1 and 2 to provide an output clock signal to the PHY layer module 401 and the MAC module 402. The output clock signal may correspond to the output clock signal CLK_out as illustrated in FIGS. 1 and 2 and may be provided based on the clock switching signal CLK_SW from the MAC layer module 402 for properly operating the multi-rate interface module, either in the first interface mode, or in the second interface mode.

In some examples, the clock switching signal CLK_SW may be provided (by the MAC) based on determining, for a subsequent operation of the MAC module 402, an operating frequency of the output clock signal CLK_out caused by auto-negotiation of the PHY layer module 401. Accordingly, the PHY layer module 401 may be configured to stop the second clock signal CLK_2 based on the determination of the auto-negotiation that the system is about to switch to e.g., the GMII mode.

As illustrated in the example of FIG. 4, the MAC module 402 and the clock switching module 404 may be integrated inside an application-specific integrated circuit (ASIC), and the PHY layer module and the multi-rate interface module are integrated inside a PHY chip 401 external to the ASIC. However, it should be noted that the exemplary architecture shown in FIG. 4 is a non-limiting example of an Ethernet system capable of switching glitchfree between the Ethernet clock sources according to the disclosure of the present document. In some practical implementations, other system configurations may be applicable, where the clock switching module 404 may be a separate component from the MAC module 402, and/or the multi-rate interface module may be located external to the PHY chip 401 as a separate component from the PHY module.

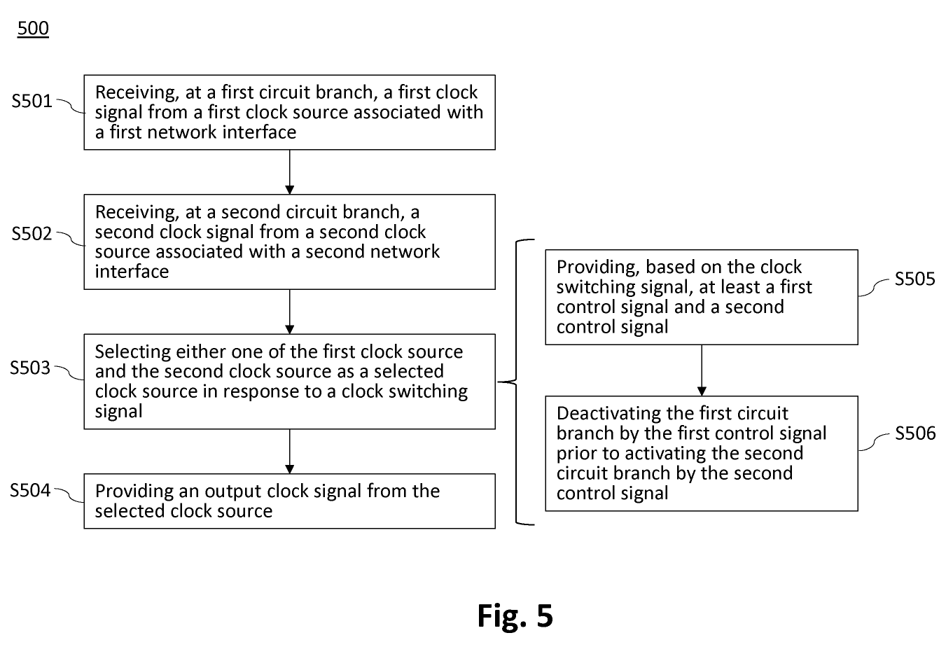

FIG. 5 shows a flow chart of an example method 500 for glitchfree switching between a plurality of independent Ethernet clock sources for operating a network interface according to embodiments of the present document. It is appreciated that the method 500 may be conducted by e.g., the clock switching device 100, 200 and the clock switching module 404 as illustrated in FIGS. 1, 2, and 4.

Specifically, the method 500 comprises receiving S501, at a first circuit branch, a first clock signal from a first clock source associated with a first network interface. The method 500 also comprises receiving S502, at a second circuit branch, a second clock signal from a second clock source associated with a second network interface. Herein, the second clock source may have a different clock rate than the first clock source. The method 500 further comprises selecting S503 either one of the first clock source and the second clock source as a selected clock source in response to a clock switching signal. In addition, the method 500 comprises providing S504 an output clock signal from the selected clock source.

More specifically, for the selection of either one of the first clock source and the second clock source, the method 500 also comprises providing S505, based on the clock switching signal, at least a first control signal for controlling the first circuit branch and a second control signal for controlling the second circuit branch. In response to the clock switching signal indicating that the second clock source is to be selected as the selected clock source, the method 500 further comprises deactivating S506 the first circuit branch by the first control signal prior to activating the second circuit branch by the second control signal for providing the second clock signal as the output clock signal.

It is appreciated that the aforementioned processing steps of the method 500 may be conducted by the respective components/units of the clock switching device 100, 200. For example, processing steps S501, S502 and S504 may be performed by the clock provision unit 101, while processing steps S503, S505 and S506 may be performed by the clock selecting unit 102 of the clock switching device 100, 200 as illustrated in FIGS. 1 and 2.

In view of the above, the proposed device/approach according to the present document realizes a clock multiplexing for switching glitchfree between the Ethernet clock sources, by using state machine circuitry (e.g., an FSM) driven by an additional clock source with a certain speed. As described above, the state machine circuitry may count the time to realize the required clock cycles for a synchronization stage before a gating latch (which may function as a first synchronous switch-off layer) and may then use a second layer with an AND gate as a second asynchronous layer. This proposed circuit configuration/structure may be triggered to take care for cases that a clock supply was already stopped at 1 level and to safely turn the 1 level into zero level that reaches the OR gate which is feeding the MAC. Subsequently, the new clock source may then be turned on accordingly to supply the MAC.

By means of the state machine circuitry, the time spent while waiting for the synchronous switch-off can be limited, and a hangup can be avoided if the clock was already stopped by the PHY before the synchronization stage is passed. That is, the state machine circuitry may ignore stopping of the clock in one of the circuit branches, reliably deactivating that circuit branch while activating another branch. In this way, the switching between the different clocks (or speed modes) can always be realized glitchfree to ensure reliable function to be performed in the Ethernet system.

Besides, by adding the clock indication signal (MII-off detection), the required time for the switching process may be decreased. Since the system may not be aware of whether the PHY runs on 2.5MHz or 25MHz, a waiting time of 1200ns (i.e., three times 2.5MHz) may be taken into account, even if a waiting time of 120ns would be enough. The MII-off detection may indicate the status and enable faster turnover to the GMII clock in such case, thereby further enhancing the efficiency of the clock switching device in performing glitch-free switching between Ethernet clocks.

It should be noted that the description and drawings merely illustrate the principles of the proposed methods and systems. Those skilled in the art will be able to implement various arrangements that, although not explicitly described or shown herein, embody the principles of the invention and are included within its spirit and scope. Furthermore, all examples and embodiment outlined in the present document are principally intended expressly to be only for explanatory purposes to help the reader in understanding the principles of the proposed methods and systems. Furthermore, all statements herein providing principles, aspects, and embodiments of the invention, as well as specific examples thereof, are intended to encompass equivalents thereof.

What is claimed is:

1. A semiconductor device configured to switch glitchfree between a plurality of independent Ethernet clock sources for operating a network interface, the semiconductor device comprising:
a clock provision circuit comprising at least a first circuit branch configured to receive a first clock signal from a first clock source associated with a first network interface, and a second circuit branch configured to receive a second clock signal from a second clock source associated with a second network interface, the second clock source having a different clock rate than the first clock source; and
a clock selecting circuit coupled to the first circuit branch and the second circuit branch and configured to select either one of the first clock source and the second clock source as a selected clock source in response to a clock switching signal,
wherein the clock provision circuit is configured to provide an output clock signal from the selected clock source, and
wherein the clock selecting circuit comprises state machine circuitry configured to receive the clock switching signal and to provide, based on the clock switching signal, at least a first control signal for controlling the first circuit branch and a second control signal for controlling the second circuit branch, such that in response to the clock switching signal indicating that the second clock source is to be selected as the selected clock source, the state machine circuitry is configured to deactivate the first circuit branch by the first control signal prior to activating the second circuit branch by the second control signal for providing the second clock signal as the output clock signal.

2. The semiconductor device of claim 1, wherein the first circuit branch comprises a first synchronous stage and a first asynchronous stage, wherein the first control signal comprises a first synchronous control signal for activating or deactivating the first synchronous stage and a first asynchronous control signal for activating or deactivating the first asynchronous stage, the first synchronous stage configured to receive the first clock signal and the first synchronous control signal, and the first asynchronous stage coupled to the first synchronous stage and configured to receive the first asynchronous control signal.

3. The semiconductor device of claim 2, wherein, for deactivating the first circuit branch, the state machine circuitry is configured to deactivate the first synchronous stage using the first synchronous control signal, and subsequently, to deactivate the first asynchronous stage using the first asynchronous control signal.

4. The semiconductor device of claim 3, wherein the second circuit branch comprises a second synchronous stage and a second asynchronous stage, wherein the second control signal comprises a second synchronous control signal for activating or deactivating the second synchronous stage and a second asynchronous control signal for activating or deactivating the second asynchronous stage, the second synchronous stage configured to receive the second clock signal and the second synchronous control signal, and the second asynchronous stage coupled to the second synchronous stage and configured to receive the second asynchronous control signal.

5. The semiconductor device of claim 4, wherein, for activating the second circuit branch, the state machine circuitry is configured to activate the second asynchronous stage using the second asynchronous control signal, and subsequently, to activate the second synchronous stage using the second synchronous control signal.

6. The semiconductor device of claim 5, wherein the second clock source is operatable at two or more distinct clock rates, and wherein the second circuit branch is configured to provide to the state machine circuitry a clock indication signal indicative of an actual operating clock rate of the second clock source among the two or more distinct clock rates based on the second control signal.

7. The semiconductor device of claim 6, wherein, in response to the clock switching signal indicating that the first clock source is to be selected as the selected clock source, the state machine circuitry is configured to deactivate the second circuit branch in response to the clock indication signal.

8. The semiconductor device of claim 7, wherein the clock indication signal is provided by the second synchronous stage based on the second synchronous control signal.

9. The semiconductor device of claim 8, wherein, in response to the clock switching signal indicating that the first clock source is to be selected as the selected clock source, the state machine circuitry is configured to deactivate the second synchronous stage using the second synchronous control signal, wherein the deactivation of the second synchronous stage causes a change of a logic level in the clock indication signal after a predefined number of cycles of the second clock signal, wherein the state machine circuitry is configured to further deactivate the second asynchronous stage in response to the change of a logic level in the clock indication signal.

10. The semiconductor device of claim 9, wherein the predefined number of cycles of the second clock signal is related to different time durations with respect to the distinct clock rates, and wherein the actual operating clock rate of the second clock source is indicated by a time duration after which the change of a logic level in the clock indication signal is caused.

11. The semiconductor device of claim 10, wherein the second circuit branch comprises one or more second synchronization flip flops configured to receive the second clock signal, a second gating latch coupled to the one or more second synchronization flip flops at an input end and configured to gate the second clock signal synchronously, and a second asynchronous AND gate coupled to the second gating latch, wherein the one or more second synchronization flip flops and the second asynchronous AND gate are configured to receive the second control signal from the state machine circuitry.

12. The semiconductor device of claim 11, wherein the second synchronous stage comprises the one or more second synchronization flip flops configured to receive the second synchronous control signal, and the second gating latch, wherein the second asynchronous stage comprises the second asynchronous AND gate configured to receive the second asynchronous control signal and an output of the second synchronous stage, and wherein the second synchronous stage further comprises a detection flip flop configured to provide the clock indication signal to the state machine circuitry based on the second synchronous control signal.

13. The semiconductor device of claim 12 depending on claim 9, wherein the second synchronous stage is deactivated by setting the second synchronous control signal to 0, and the detection flip flop is configured to change a logic level in the clock indication signal to 0 after the predefined number of cycles of the second clock signal in response to the deactivation of the second synchronous stage, and wherein the state machine circuitry is configured to further deactivate the second asynchronous stage in response to detecting a 0-level in the clock indication signal.

14. The semiconductor device of claim 13, wherein the predefined number of cycles of the second clock signal is dependent on the number of the one or more second synchronization flip flops.

15. A method for switching between a plurality of independent Ethernet clock sources for operating a network interface, wherein the method comprises:
receiving, at a first circuit branch, a first clock signal from a first clock source associated with a first network interface;
receiving, at a second circuit branch, a second clock signal from a second clock source associated with a second network interface, the second clock source having a different clock rate than the first clock source;
selecting either one of the first clock source and the second clock source as a selected clock source in response to a clock switching signal; and
providing an output clock signal from the selected clock source, wherein the selection of either one of the first clock source and the second clock source comprises:
providing, based on the clock switching signal, at least a first control signal for controlling the first circuit branch and a second control signal for controlling the second circuit branch, and, in response to the clock switching signal indicating that the second clock source is to be selected as the selected clock source,
deactivating the first circuit branch by the first control signal prior to activating the second circuit branch by the second control signal for providing the second clock signal as the output clock signal.

16. The method of claim 15, wherein the first control signal comprises a first synchronous control signal for activating or deactivating a first synchronous stage of the first circuit branch and a first asynchronous control signal for activating or deactivating a first asynchronous stage of the first circuit branch coupled to the first synchronous stage, the method further comprising receiving the first synchronous control signal at the first synchronous stage and receiving the first asynchronous control signal at the first asynchronous stage.

17. The method of claim 16, deactivating the first circuit branch further comprising deactivating the first synchronous stage using the first synchronous control signal, and subsequently, deactivating the first asynchronous stage using the first asynchronous control signal.

18. The method of claim 15, wherein the second control signal comprises a second synchronous control signal for activating or deactivating a second synchronous stage of the second circuit branch and a second asynchronous control signal for activating or deactivating a second asynchronous stage of the second circuit branch coupled to the second synchronous stage, the method further comprising receiving the second synchronous control signal at the second synchronous stage and receiving the second asynchronous control signal at the second asynchronous stage.

19. The method of claim 18, activating the second circuit branch further comprising activating the second asynchronous stage using the second asynchronous control signal, and subsequently, activating the second synchronous stage using the second synchronous control signal.

20. The method of claims claim 15, wherein the second clock source is operatable at two or more distinct clock rates, the method further comprising providing a clock indication signal indicative of an actual operating clock rate of the second clock source among the two or more distinct clock rates based on the second control signal, and optionally, in response to the clock switching signal indicating that the first clock source is to be selected as the selected clock source, deactivating the second circuit branch in response to the clock indication signal.
